(19) United States
(12) Patent Application Publication
(10) Pub. No.: US 2018/0027866 A1
(43) Pub. Date: Feb. 1, 2018

(54) Condiment Distribution Device

(71) Applicant: William Carroll, St. Louis, MO (US)

(72) Inventor: William Carroll, St. Louis, MO (US)

(21) Appl. No.: 15/664,721

(22) Filed: Jul. 31, 2017

Related U.S. Application Data
(60) Provisional application No. 62/368,534, filed on Jul. 29, 2016.

(51) Int. Cl. A23P 20/15; A23L 7/191

(52) U.S. Cl. CPC A23P 20/15; A23L 7/191; A23V 2002/00

(57) ABSTRACT

A condiment distribution device. The condiment distribution device includes a tube having an open upper end and an open lower end defining a channel therebetween. A plurality of apertures are disposed on the tube. The device further includes a funnel comprising an open upper end and a connector having an open lower end, wherein the connector is removably securable to the open upper end of the elongated tube. The tube can be inserted into a container of food and a condiment poured into the open upper end of the funnel, such that it flows out of the apertures and open lower end of the tube onto the food. The condiment distribution device is configured to evenly distribute a condiment throughout a container of food.

### CROSS REFERENCE TO RELATED APPLICATIONS

This application claims the benefit of U.S. Provisional Application No. 62/368,534 filed on Jul. 29, 2016. The above identified patent application is herein incorporated by reference in its entirety to provide continuity of disclosure.

### FIELD OF THE INVENTION

The present invention relates to culinary utensils and tools. More specifically, the present invention provides a condiment distribution device configured to evenly distribute a condiment throughout a container of food.

### BACKGROUND OF THE INVENTION

Many individuals enjoy consuming snacks with added condiments. Condiments can be added to a variety of foods to enhance present flavors or to provide additional flavoring. An example of such a food is popcorn, which is often topped with melted butter. It can be difficult to apply melted butter to a container of popcorn such that the melted butter is evenly distributed. One method of adding melted butter to a container of popcorn is to pour the butter over the top of the container. While the top layer of popcorn receives the melted butter, and while some of the melted butter filters down to popcorn in the lower part of the container, much of the popcorn remains untouched by the butter, resulting in an uneven distribution of flavor.

Since it can be difficult to evenly apply a condiment to a food item, some individuals may attempt to evenly distribute the condiment after it has been applied to the food. In the case of popcorn and melted butter, once melted butter is poured into the popcorn container, some individuals may shake the container to distribute the melted butter. However, this can cause butter to spill from the container, potentially making a mess and wasting food. Further, if the melted butter is very hot, shaking the container can cause the melted butter to spatter on to the individual, which may cause injury. In order to address the above problems, the present invention provides a novel condiment distribution device that is configured to evenly distribute a condiment throughout a container of food.

### SUMMARY OF THE INVENTION

In view of the foregoing disadvantages inherent in the known means of condiment distribution now present in the known art, the present invention provides a condiment distribution device wherein the same can be utilized for providing convenience for the user when applying a condiment to a container of food. The condiment distribution device includes a tube having an open upper end and an open lower end defining a channel therebetween. A plurality of apertures are disposed on the tube. The device further includes a funnel comprising an open upper end and a connector having an open lower end, wherein the connector is removably securable to the open upper end of the elongated tube.

An object of the present invention is to provide a condiment distribution device that is configured to evenly distribute a condiment throughout a container of food.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side view of an embodiment of the condiment distribution device.

FIG. 2 shows a perspective view of an alternate embodiment of the condiment distribution device.

FIG. 3 shows a side view of an alternate embodiment of the condiment distribution device.

FIG. 4 shows a side view of an embodiment of a condiment distribution device inserted into a container of popcorn.

### DETAILED DESCRIPTION OF THE INVENTION

Reference is made herein to the attached drawings. Like reference numerals are used throughout the drawings to depict like or similar elements of the condiment distribution device. For the purposes of presenting a brief and clear description of the present invention, the preferred embodiment will be discussed as used for evenly distributing a condiment throughout a container of food. The figures are intended for representative purposes only and should not be considered to be limiting in any respect.

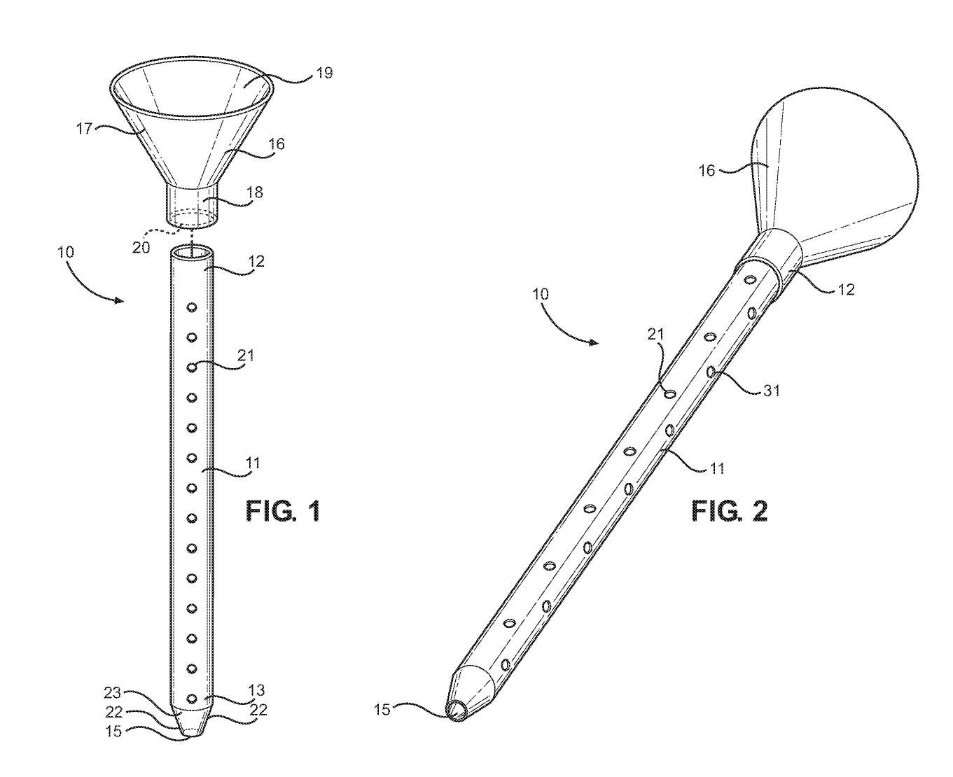

Referring now to FIG. 1, there is shown a side view of an embodiment of the condiment distribution device. The condiment distribution device 10 includes an elongated tube 11 having an upper end 12 and a lower end 13. An upper opening 14 is disposed on the upper end 12 and a lower opening 15 is disposed on the lower end 13, defining a channel therebetween that extends through the length of the tube 11. Additionally, a plurality of apertures 21 are disposed along the length of the tube 11, wherein the apertures 21 are in fluid communication with the channel. In the shown embodiment, the apertures 21 are disposed on the tube 11 in a linear arrangement. In some embodiments, the tube 11 may comprise multiple groups of linearly arranged apertures disposed around the circumference thereof.

The lower end 13 of the tube 11 comprises a conical portion 22. The conical portion 22 tapers inwardly from an upper end 23 to a lower end 24 thereof, such that the tip or lower end 24 has a diameter less than a diameter of the upper end 23. The narrower tip allows the device 10 to be easily inserted into a container of food, such as a bucket of popcorn, in order to apply a condiment thereto.

The device 10 further includes a funnel 16 comprising a conical portion 17 having an open upper end 19 and a connector portion 18 having an open lower end 20. The open lower end 20 of the connector 18 is configured to receive the upper end 12 of the tube 11. In this way, the tube 18 is removably securable to the connector 18 of the funnel 16 via frictional engagement therewith. However, in alternative embodiments, the the tube 18 is removably securable to the funnel 16 via any fastener adapted to maintain fluid communication therebetween. Additionally, the width of the funnel 16 is greatest at the open upper end 19 thereof, so that a condiment may easily be poured into the funnel 16 where it will ultimately flow out of the apertures 21 and the lower opening 15 of the tube 11.

Referring now to FIG. 2, there is shown a perspective view of an alternate embodiment of the condiment distribution device. In an alternate embodiment, the tube 11 includes a first plurality of apertures 21 and a second plurality of apertures 31 that are disposed along the tube 11 in an offset arrangement, such that each individual aperture of the first plurality of apertures 21 is offset from an adjacent aperture of the second plurality of apertures 31. When a condiment is poured into the funnel 16, it flows through the connector 18 into the tube 11, and flows out of the tube via the lower opening 15, the first plurality of apertures 21, and the second plurality of apertures 21, 31.

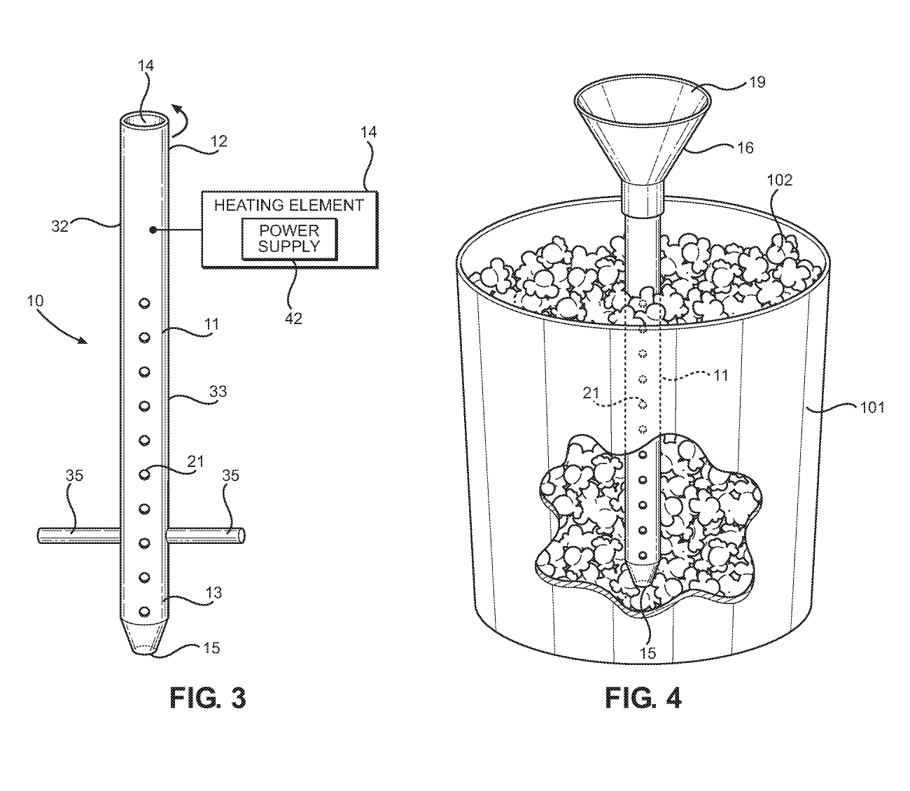

Referring now to FIG. 3, there is shown a side view of an alternate embodiment of the condiment distribution device. In another alternate embodiment, the device 10 includes a heating element 41 disposed within the tube 11. The heating element 41 is operably connected to a power supply 42, such as a battery. The heating element 41 is configured to heat a condiment flowing through the tube 11, so that it is heated when applied to a food item. The heating element 41 may be a resistive heating element or any other suitable heating element 41 capable of heating a condiment.

The upper opening 14 on the upper end 12 of the tube 11 may be removably secured to the rotating condiment dispensing device 10, because rotation of the tube 11 provides for a more even application of the condiment. In the shown embodiment, the tube 11 comprises one or more stirring rods 35 extending radially and outwardly therefrom which help to evenly distribute a condiment throughout the food. In the shown embodiment, two stirring rods 35 are disposed on opposing sides of the tube 11, such that the two stirring rods 35 are linearly aligned along their respective horizontal axes, which provides for even stirring of the condiment as it exits the apertures 21 and the open lower end 15 of the tube 11. Further, a length of each stirring rod 35 is less than the length of the tube 11. In alternate embodiments, the one or more stirring rods 35 can be disposed elsewhere along the tube 11. In an embodiment with both stirring rods 35 and the heating element 41, the stirring rods 35 are disposed toward the lower end 13 of the tube 11 and the heating element 41 is disposed toward the upper end 12 of the tube 11.

In the shown embodiment, the tube 11 comprises a solid wall 32 disposed on an upper third thereof, and a perforated wall 33 having a plurality of apertures 21 thereon disposed on a lower third of the tube 11, such that an upper third of the tube 11 has no apertures, while a lower two thirds of the tube has apertures 21 thereon. The solid wall 32 of the upper third of the tube 11 prevents condiment from spilling if an upper portion of the tube 11 is exposed after insertion into a container of food for condiment application.

Referring now to FIG. 4, there is shown a side view of an embodiment of a condiment distribution device inserted into a container of popcorn. In use, the tube 11 is inserted into a container 101 of popcorn 102 so that a condiment such as melted butter can be easily and evenly applied thereto. A user may pour melted butter into the upper opening 19 of the funnel 16. The melted butter then flows downward via gravity through the tube 11, and exists the tube through the apertures 21 and the lower opening 15 thereof. Since the apertures 21 are disposed along the length of the tube, the melted butter exits the tube 11 evenly along the length thereof, which evenly distributes the melted butter to popcorn 102 in the upper, lower, and middle portions of the container 101. In this way, the condiment distribution device can be utilized to easily apply melted butter to a container of popcorn 102, such that the melted butter is evenly distributed throughout the container 101.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A condiment distribution device, comprising:
a tube having an open upper end and an open lower end defining a channel therebetween;
a plurality of apertures disposed on the tube;
a funnel comprising an open upper end and a connector having an open lower end;
wherein the connector is removably securable to the open upper end of the elongated tube.

2) The condiment distribution device of claim 1, wherein the lower end of the tube comprises a conical portion, wherein the conical portion tapers inwardly from an upper end to a lower end thereof.

3) The condiment distribution device of claim 1, wherein the plurality of apertures are arranged in a linear arrangement.

4) The condiment distribution device of claim 1, wherein the plurality of apertures comprises a first group of apertures and a second group of apertures, wherein the first group of apertures and the second group of apertures are arranged in an offset arrangement.

5) The condiment distribution device of claim 1, wherein the connector is removably securable to the upper end of the elongated tube via frictional engagement therewith.

6) The condiment distribution device of claim 1, further comprising a plurality of stirring rods disposed on the elongated rod and extending radially outwardly therefrom.

7) The condiment distribution device of claim 6, wherein the plurality of stirring rods comprises at least two stirring rods that are linearly aligned along a common horizontal axis.

8) The condiment distribution device of claim 6, wherein a length of each of the plurality of stirring rods is less than a length of the elongated tube.

9) The condiment distribution device of claim 1, further comprising a heating element disposed within the channel, wherein the heating element is configured to heat a condiment that flows through the channel.

10) A condiment distribution device, comprising:
a tube having an open upper end and an open lower end defining a channel therebetween;
an upper third of a length of the tube comprising a solid wall;
a lower two thirds of a length of the tube comprising a plurality of apertures disposed thereon;
a heating element disposed within the channel configured to heat a condiment that flows through the channel;
one or more stirring rods disposed on the tube extending radially and outwardly therefrom;
a funnel comprising an open upper end and a connector having an open lower end;
wherein the connector is removably securable to the open upper end of the elongated tube.
